(19) United States
(12) Patent Application Publication
(10) Pub. No.: US 2020/0242797 A1
(43) Pub. Date: Jul. 30, 2020

(54) AUGMENTED REALITY LOCATION AND DISPLAY USING A USER-ALIGNED FIDUCIAL MARKER

(71) Applicant: Huntington Ingalls Incorporated, Newport News, VA (US)

(72) Inventors: Daniel J. McPeters, Newport News, VA (US); Durrell R. Blanks, Allston, MA (US); Mary C. McLaughlin, Newport News, VA (US)

(21) Appl. No.: 16/745,521

(22) Filed: Jan. 17, 2020

Related U.S. Application Data
(60) Provisional application No. 62/797,410, filed on Jan. 28, 2019.

(51) Int. Cl. G06T 7/73; G06T 17/00

(52) U.S. Cl. CPC G06T 7/73; G06T 2207/30204; G06T 17/00

(57) ABSTRACT

In a method for orienting AR information for display to a user of a user device disposed within a dynamic environment, a physical fiducial marker is placed within a target area of the dynamic environment. A digitally modeled representation of the target area is displayed on the user device and a digital fiducial marker is positioning in the display by the user. A real-time digital image of the target area and the physical fiducial marker is captured and displayed on the user device. The digital fiducial marker is associated with the physical fiducial marker and the modeled representation of the target area is repositioned by the user to match the captured digital image. The AR information is then displayed in conjunction with the real-time digital image of the target area with the AR information positioned adjacent to a location of the digital fiducial marker on the display.

This application claims priority to U.S. Provisional Application 62/797,410 filed Jan. 28, 2019, the complete disclosure of which is incorporated herein by reference.

### BACKGROUND OF THE INVENTION

This application relates generally to the use of augmented reality (AR) to display information relating to a target object or area on a mobile device. More specifically, the present invention relates to the use of portable, user-aligned fiducial markers to establish mobile device pose for proper display of augmented reality information.

One of the basic units required for creating an augmented reality visual representation is the image target or marker (referred to herein as a “fiducial” or “fiducial marker”) that is used to locate and orient the viewer relative to the augmented environment. The ability to recognize and track image targets enables the positioning and orientation of virtual objects, such as 3D models and other media, in relation to real world images viewed through the camera of a mobile or other viewing device. The virtual object tracks the position and orientation of the image in real-time so that the viewer's perspective on the object corresponds with their perspective on the image target. Thus, the virtual object appears to be a part of the real world scene.

Many operations that make use of AR require and rely on known pre-positioned fiducial markers, the locations and orientations of which are programed into a software solution. In many environments (e.g., the interior of buildings or ships under construction), however, the configuration of interior spaces are constantly changing and new, unforeseen equipment (ladders, pipes, staging, etc.) may be present. In such highly changeable environments, the use of a fixed fiducial marker may be problematic. For example, an area/location in which a pre-positioned fiducial marker was placed may no longer be accessible or the marker may be partially or totally blocked or obscured.

### SUMMARY OF THE INVENTION

An illustrative aspect of the invention provides a method of orienting AR information for display to a user of a user device disposed within a dynamic environment. The method comprises placing a physical fiducial marker within a target area of the dynamic environment, displaying, by the user device in a device display, a digitally modeled representation of the target area, and positioning, by the user in the display, a digital fiducial marker. The method further comprises capturing and displaying, by the user device, a real-time digital image of the target area and the physical fiducial marker and associating the digital fiducial marker with the physical fiducial marker. The method still further comprises repositioning, by the user in the display, the modeled representation of the target area to match the captured digital image and displaying, by the user device, the AR information in conjunction with the real-time digital image of the target area. The AR information is displayed in a position adjacent to a location of the digital fiducial marker on the display.

Another aspect of the invention provides a method of displaying on a user device AR information associated with a physical fiducial marker disposed within a target area. The method comprises displaying to a user of the user device a digitally modeled representation of the target area and receiving user-entered placement information for a digital fiducial marker. The placement information establishes a position of the digital fiducial marker relative to the modeled representation of the target area. The method further comprises capturing by an image capturing device a real-time digital image of the target area and the physical fiducial marker and associating the digital fiducial marker with the physical fiducial marker. The method still further comprises receiving image placement information from the user to match the modeled representation of the target area to the captured digital image and displaying the AR information in conjunction with the real-time digital image of the target area. The AR information is displayed in a position adjacent to a location of the digital fiducial marker in the image.

Another aspect of the invention provides a mobile user device comprising a user interface comprising a display screen and a user input mechanism, a communication interface configured for selective communication over a network, an image capturing device for selectively capturing digital images, and a data processor in communication with the user interface, the communication interface, and the image capturing device. The mobile user device also comprises a memory accessible by the data processor and containing an AR display application configured to cause the data processor to display on the display screen a digitally modeled representation of a target area and receive, from a user via the user input mechanism, placement information for a digital fiducial marker. The placement information establishes a position of the digital fiducial marker relative to the modeled representation of the target area. The application is further configured to cause the data processor to receive, from the image capturing device, a real-time digital image of the target area and a physical fiducial marker disposed within the target area and to associate the digital fiducial marker with the physical fiducial marker. The application is still further configured to cause the data processor to display the digital image of the target area on the display screen with the modeled representation of the target area and the digital fiducial marker, to receive, from the user via the user input mechanism, image placement information to position the modeled representation of the target area and the digital fiducial marker on the display screen relative to the captured digital image, and to display on the display screen the AR information in conjunction with the real-time digital image of the target area. The AR information is displayed in a position adjacent to the digital fiducial marker.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic illustration of an AR generation and display system usable in conjunction with the methods of the invention;

FIG. 2 is a flow diagram of a method of using an alignable fiducial marker to display AR information according to an embodiment of the invention;

FIG. 3 is a schematic representation of the positioning of a user-aligned fiducial marker in a target area;

FIG. 4 is a schematic representation of a target area digital model displayed on a mobile interface device; and

FIGS. 5 and 6 are schematic representations of a target area digital model superimposed over a captured image of a target area as displayed on a mobile interface device in accordance with an embodiment of the invention.

### DETAILED DESCRIPTION OF THE INVENTION

While the invention will be described in connection with particular embodiments, it will be understood that the invention is not limited to these embodiments. On the contrary, it is contemplated that various alternatives, modifications and equivalents are included within the spirit and scope of the invention as described.

The present invention alleviates the problems associated with the use of pre-positioned fiducial markers. Methods according to embodiments of the present invention allow mobile device users to place physical fiducial markers in an environment space and then dynamically position the marker in a digital model so as to match its location in the physical environment. Once this has been accomplished, the newly placed marker can be used as a reference for display of AR content. Over time, the fiducial marker may be replaced or repositioned as necessitated by changes or additions to the physical space to assure that the marker is in an unobstructed location within the space.

While the dynamic structural environments used in many of the examples and illustrative embodiments used herein to describe the invention relate to ships and other vessels, it will be understood that the invention is not limited to such environments. The invention can be used in, without limitation, land vehicles, buildings and any other static or dynamically variable structure.

The systems of the invention use AR as the primary medium for presenting environment or object-related information to a user. AR allows presentation of such information on mobile interface devices in graphical or textual form overlaid or adjacent an environmental area or object as it appears in the camera-generated view on the device screen.

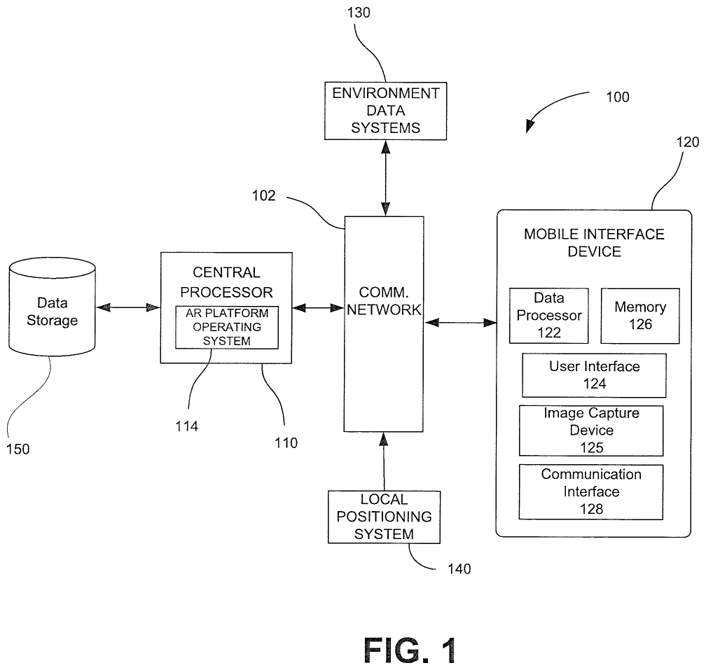

A generalized system 100 for generating and displaying real-time AR information is illustrated in FIG. 1. The system 100 is configured for obtaining and storing information on a dynamic structural environment such as a ship or building and objects disposed within that environment. The system 100 comprises a central processor 110 in communication with one or more mobile interface devices 120 via a communication network 102. The central processor may include or be in communication with a relational database structure (not shown) as is described in U.S. Pat. No. 9,996,551 (the “'551 patent”), the complete disclosure of which is incorporated herein by reference in its entirety. In general, the central processor 110 is configured to receive captured object information from the mobile interface devices 120 and to extract information relating to the environment or an object in the environment, generate AR information for display on a requesting mobile interface device, and transmit the AR information to the requesting mobile interface device 120.

The central processor 110 may be configured to receive information from a local positioning system 140 via the communications network 102 or a different network. The central processor may, alternatively or in addition, receive information from a global positioning system. The central processor may be configured to use the received positioning information in conjunction with information from a requesting mobile interface device 120 and known/stored structural information (e.g., a three dimensional model) to determine the pose of the mobile interface device 120 within the environment. As used herein, “pose” means the position (x,y,z) and orientation (θ,φ,ζ) of an object in a particular physical space. The system may be configured to resolve spatial differences between the coordinate system established based on the known structural information and the data received from the local positioning system 140 that result from changes in the dynamic structure. Such changes may, for example result from expansion, bending or other deformation of the dynamic structure.

The central processor 110 may be configured to receive information from an environment data system 130 via the network 102 or another network. The environment data system 130 is configured for measurement or determination of parameters associated with the structural environment or an object or objects within the structural environment. Such parameters may include, but are not limited to spatially mapped or mappable data obtained from sensors (e.g., radiation or temperature sensors) with known locations in the structural environment, spatially mapped or mappable data (e.g., weight distribution or surface topography) associated with a particular object in the environment, and system or device status information (e.g., electrical circuit energization status). In some embodiments, the environmental data systems 130 may include a metrology system adapted to provide measurements of specific parameters for particular object types. The central processor 110 is configured to process information from the environmental data systems 130 and use it with the pose information for the requesting mobile interface device 120 to generate AR information that can be transmitted to the mobile interface device 120 for display and/or associated with the space in which the mobile device is located.

In various embodiments of the invention, information processed by the central processor 110 may include asset location information from a global or local positioning system, visual or graphical information received from the mobile interface devices, observational information from users, and operational or other data from instrumentation systems associated with the environment or particular assets. Any or all of such information can be used by the central processor 110 to update object-related information and/or generate information for display via AR images that can be superimposed on the mobile device user's view of the environment or an object in the environment. Such AR information may be stored and associated with particular spaces within the dynamic structure and/or with identifiable objects. It may also be associated, in particular, with one or more fiducial markers. The mobile interface devices used in the systems of the invention can make use of AR information in a variety of ways that allow the user to conduct inspection, maintenance, repair, and replacement tasks in relation to particular assets. AR can also be used to assist a user in identifying safety hazards, locating objects, or simply navigating within the dynamic environment.

The mobile interface device 120 may be any mobile computing solution that is used by a user to facilitate communication with and display information from the central processor 110. The mobile interface device 120 may be, for example, a tablet computer, a smartphone, or a wearable heads-up display. The mobile interface device 120 includes a data processor 122, a user interface 124 including a display (such as a screen), an image capturing device (e.g., a visible light or infrared camera) 125, and a communication interface 128. It may also have features including, but not limited to an image capturing device, a microphone, and one or more speakers. The mobile interface device 120 may be, in a particular embodiment, a wearable head-mounted device (HMD) such as that described in U.S. application Ser. No. 14/210,730, filed Mar. 14, 2014, the complete disclosure of which is incorporated herein by reference. In preferred embodiments, the mobile interface device 120 is equipped or configured to display AR images/information to a user. The mobile interface device 120 may include one or more accelerometers or other motion detection sensors. Each mobile interface device 120 may include one or more unique identifiers. In some embodiments, some or all of the mobile interface devices 120 may include one or more local positioning receivers, image and object recognition, audio queues, or electromagnetic field (EMF) receivers or detectors (for GPS, WiFi, or RFID reception or light detection).

The communication interface 128 may be configured to establish and support wired or wireless data communication capability for connecting the mobile device 120 to the communication network 102 or other communication network. The communication interface 128 can also be configured to support communication with a short-range wireless communication interface, such as near field communication, radio-frequency identification, and Bluetooth.

The mobile interface device 120 also includes a memory 126, which may have stored therein one or more applications usable by the data processor 122 to carry our various functions. In some embodiments, the memory 126 may have stored therein an application configured for determining the general location of the mobile device 120 within a dynamic environment. In particular, the application may enable the device 120 to determine a particular space or area within the environment. In some embodiments, the mobile interface device 120 may be configured to receive information from the local positioning system 140 to make this determination. In other embodiments, an application may be configured to cause the mobile device 120 to transmit information to the central processor 110 and/or an environment data system and receive back information relating to the area in which the mobile device 120 is disposed.

In various embodiments of the invention, the memory 126 may have stored therein one or more AR display applications configured to facilitate or carry out methods of displaying AR information including, in particular, the methods described in more detail hereafter. An AR display application may be configured to direct the data processor 122 to receive information from the central processor 110 or other external sources via the communication interface 128 and the user via the user interface 124. The application may be further configured to direct the data processor to use such information for the construction of AR information that is displayable via the display of the user interface 124. In some embodiments, an AR display application may be configured to direct the data processor 122 to receive information via the user interface to direct the placement of a digital marker within a digital model of a target area and then to match a display of the digital model to a real-time image of the area captured by the image capture device 125. The application may be further configured to associate the digital marker with a physical marker appearing in the captured image and to establish a display position of the AR information that places the AR information adjacent the physical marker when the AR information is displayed on the user interface display screen as an overlay over the real-time image.

The communication network 102 may be a wireless network, a wired network or any combination of wireless network and wired network. In a preferred embodiment, the communications network 102 is a wireless communications network, allowing the mobile interface devices 120 to communicate wirelessly with the central processor 110. The communication network 102 may, in particular, be or include a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal.

The central processor 110 may be or comprise one or more servers, data processing machines, or network-enabled computers and may host an AR operating system 114. The AR operating system 114 may be configured to control the interaction of the hardware and software components of a data storage unit 150 comprising a relational database structure. The relational database structure is configured to provide a logical framework that allows digital information to be associated with physical spaces and objects. This framework includes addresses for both tangible objects as well as individual point addresses within a coordinate system for the structural environment. In an exemplary embodiment, this coordinate system is based on a three dimensional (3D) structural model of the environment (e.g., the ship or building). Preferably, the 3D model provides a complete detail of the environment including every space, room or compartment where objects may be disposed.

The AR operating system 114 is configured to assemble AR information for transmission to and display by the mobile device 120. The AR information may be constructed using the processed environment data from the environment data systems 130 for a target area using any of various techniques known in the art. The AR information may be presented for display as text or as graphical images that can be superimposed over real-time images captured by the mobile device 120. Of particular interest in the present invention is that the AR information may comprise specific parameters relating to the portion of the environment in which an associated fiducial marker is placed. The AR information may be displayed on a mobile device 120 on which an image of the fiducial marker has been captured.

In particular embodiments, the AR information may include information on a target object that is usable by a mobile device user to conduct maintenance, construction, machining or other operations in a target area or on a target object. As used herein, the term “target area” or “target object” refers to an area or object/structure in a dynamic environment that can be identified by the system and associated with location, status, condition or other area-related or object-related information. The AR information may be presented on a mobile device in response to software recognition of the presence of an associated fiducial marker in a camera image captured by the mobile device. The information may be presented as an AR image superimposed over the camera image of the target area in which the fiducial marker is disposed.

The central processor 110 may be configured or may comprise a processor or processing module and computer executable software (e.g., on a tangible computer-readable medium) configured to perform various processing functions relating to object recognition, including feature extraction to extract lines, edges, ridges, or other localized interest points from an image; detection or segmentation to select a specific set of interest points within an image or segment multiple image regions that contain a specific object of interest; image recognition to categorize a detected object into a particular category; noise reduction; contrast enhancement; and/or space scaling, for example.

The relational database structure may include a domain coordinate management system that maintains spatial addresses for all spaces within the domain of the structural environment. The domain coordinate management system may be configured to receive spatial address information from both the local positioning system 140 and from the three dimensional structural model. The domain coordinate management system is configured to resolve spatial differences between the coordinate system established by the 3D model of the structure and any available telemetry data received from the local positioning system 140 as a result of changes in the dynamic structure. Such differences may be particularly significant in, for example, a large vessel underway at sea. Ships (particularly large ships) are not rigid bodies.

It will be understood that various processing components of the system 100 may be combined into a single processor or further subdivided into multiple processors or servers. It will be appreciated that in some cases, multiple instances of a particular component of the system 100 may be used. Moreover, the system 100 may include other devices not depicted in FIG. 1.

The system 100 can be used to provide a mobile device user with real-time AR information on the characteristics or condition of a target areas or object in response to the presence of a fiducial marker disposed in the target area or on or around the target object in a static or dynamic environment. Methods of associating AR information with a fixed fiducial marker are well-known. With the fixed position and orientation of the fiducial marker known relative to the space in which it is disposed, AR information relevant to the space can be displayed as a properly positioned overlay relative to the geometry of the space and/or objects disposed within it. The present invention provides the capability to place (or re-place) a physical fiducial marker and then associate (or re-associate) AR information with that marker so that the AR information will be properly oriented when displayed in conjunction with a camera view of the marker and the space in which it is disposed. This is accomplished without the need to measure or otherwise determine the exact location of the physical fiducial marker.

In an illustrative method according to an embodiment of the invention, a user may dynamically locate a fiducial marker in a digital model to match its location in the physical environment. First, the user places a physical fiducial marker in a target area within a static or dynamic environment (ship compartment, construction site etc.). The user then places a digital version of the fiducial marker in a digital model of the target area, effectively aligning the physical environment with the digital environment.

The physical fiducial marker is most often an image or unique visual cue but other methods may be used (e.g., unique, recognizable objects, local positioning beacons, or a physical location such as a device docking station or holder). A digital twin of the fiducial marker may be created or defined which will be paired with the physical fiducial marker. This may require software that recognizes the pairing of the two fiducial markers, physical and digital. Software methods may include, but are not limited to the following technologies or methods: Computer Vision technology, IMU data, radio signaling etc.

The methods of the invention make use of digital models of target areas where fiducial markers may be placed. These models need not be highly detailed, but should have enough detail that their correspondence to their associated physical target areas are relatable to the user. While not necessarily detailed, the models should be accurate, as the accuracy of the augmentations as a result of this process may be directly dependent on the accuracy of the digital models.

The digital model of a target area may be configured for display on a mobile interface device in such a way that the device user can manipulate the view of the model. This allows the user to overlay the model over a real-time camera view of the target area and change the model view of the target area until it matches physical view. The user can then add a digital fiducial marker to the model, defining its position so as to match that of the physical marker. This effectively pairs the physical and digital fiducial markers with matching reference points between the physical and digital environments.

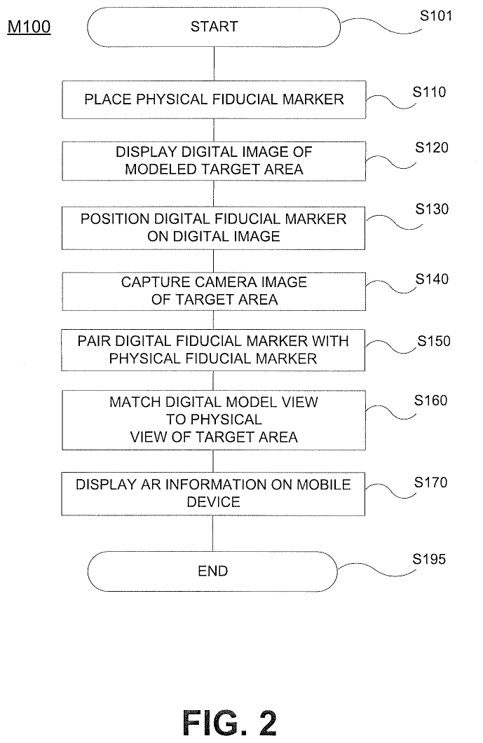

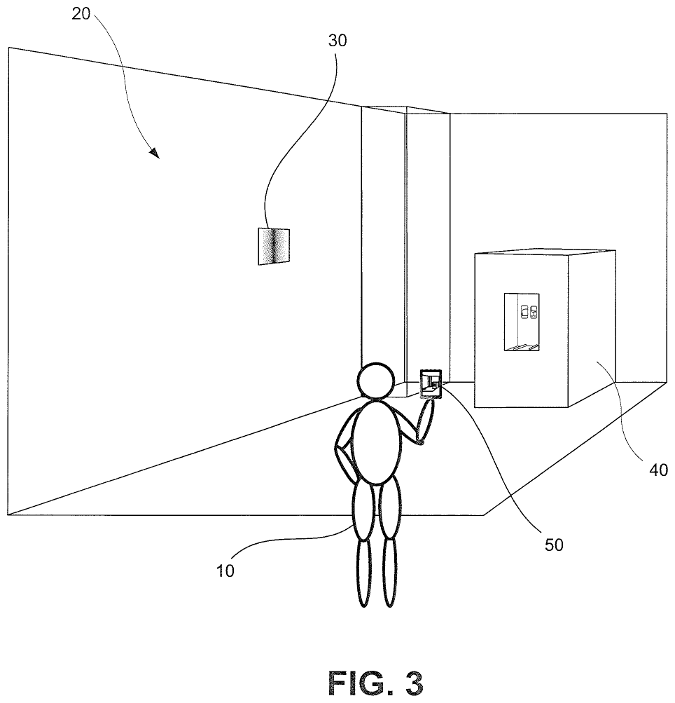

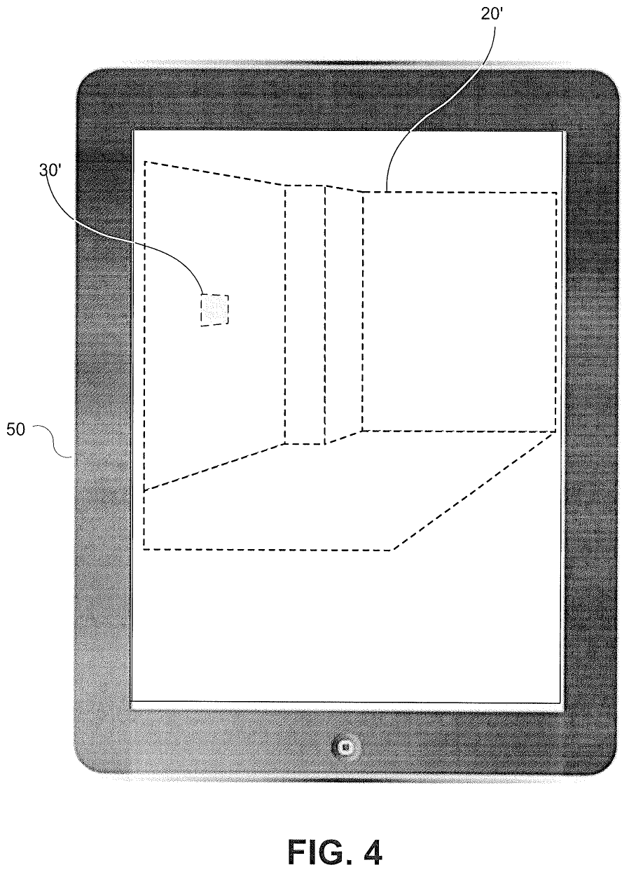

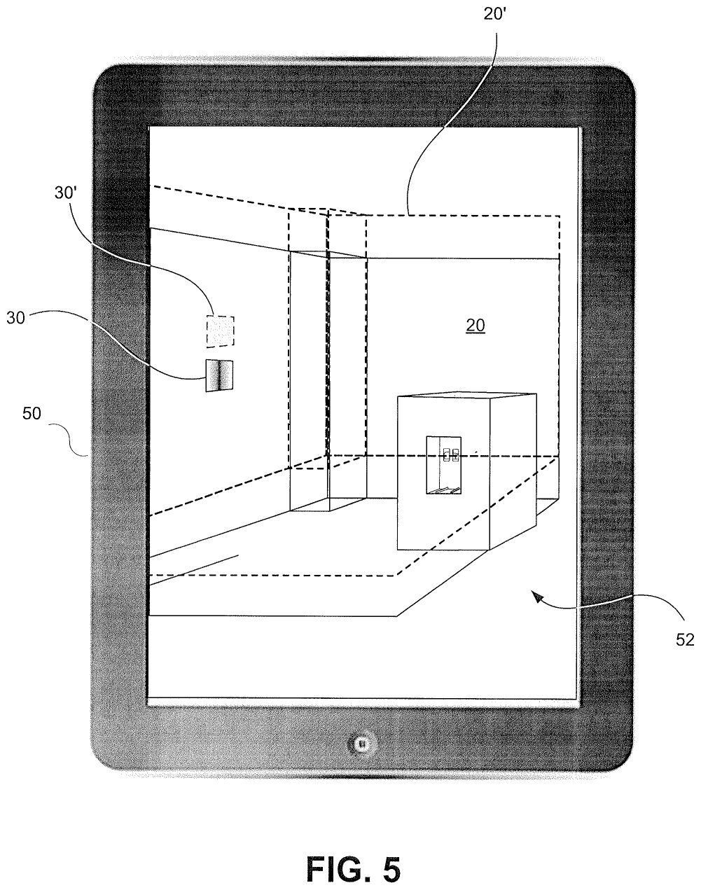

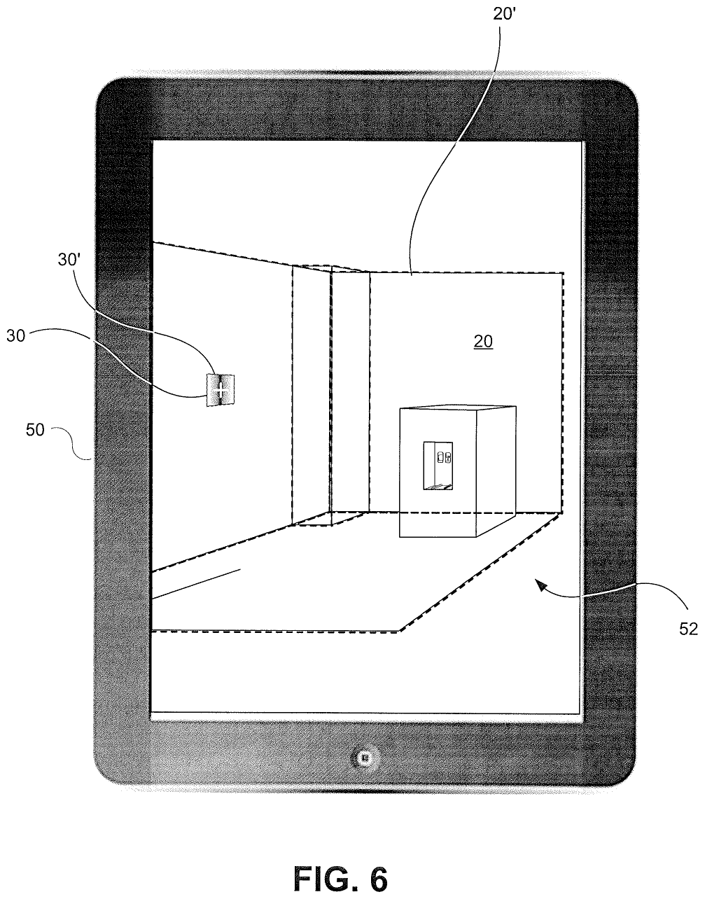

With reference to FIGS. 2-6, a method M100 of displaying AR information according to an embodiment of the invention begins at S101. In this method, a user 10 may be positioned so as to view some or all of a target area 20 having particular geometric characteristics. At S110, a physical fiducial marker 30 is placed in a viewable location within the target area 20. At S120, within an application programmed into the mobile device 50, the user 10 selects and displays a model image 20′ of the target area 20. At S130, the user 10 selects a location on the digital model image 20′ for the position of a digital fiducial marker corresponding to the location of the physical fiducial marker 30. This will signal the software to move the digital marker 30′ to the approximate digital correlation of the physical fiducial marker 30 in the display of the mobile device 50. At S140, the user 10 captures and displays a real-time camera view 52 of the target area 20—including the marker 30 and equipment 40 disposed in the target area 20—using a mobile interface device 50. At S150, the application associates the digital and physical fiducial markers. At S160, the user 10 manipulates the model image 20′ until it matches the mobile device view of the target area 20. The application is configured to allow the user to translate, and in some cases, rotate the model image 20′. FIG. 5 shows the model image 20′ overlaid on the captured image of the target area 20. Notably, the model image 20′ is a low detail wire-frame that does not include or account for details such as the equipment 40 disposed within the target area 20. In FIG. 6, the model image 20′ has been translated downward so as to align it with the image of the target area 20. Further adjustment may be made by the user 10 so that the model image 20′ exactly matches and is aligned with the geometry of the target area 20. At S170, the AR information associated with the physical fiducial marker 30 may be displayed on the mobile device. In some embodiments, the AR information may be retrieved from a memory of the mobile device 50. In other embodiments, the AR information may be stored externally (e.g., on a shared cloud, a network server, or other data storage) and requested by the application. In some cases, the AR information may be requested of and received from the central processor 110. If desired, the user 10 can fine-tune the position of the digital model 20′ and/or the digital marker 30′ to more accurately align the digital environment with the physical environment. The method ends at S195.

The AR information may be presented as text displayable in conjunction with the visual display of the target area or as graphical imagery that can be superimposed over an appropriate portion of the visual display. The graphical imagery could, for example, be or include one or more graphical representations of parameters measured by environmental data systems, a representation of desired characteristics, or deviations from desired characteristics.

The methods of the invention are usable by individuals conducting virtually any operation associated with an object or area, including without limitation any form of machining, welding, construction, assembly, or maintenance operation. Operations may also include instances where a status of the object is changed. An example of this is an instance where the object is a component in an electrical circuit and the operator is required to effect a change in the connectivity or energization status of that component.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

What is claimed is:

1. A method of orienting augmented reality (AR) information for display to a user of a user device disposed within a dynamic environment, the method comprising:
placing a physical fiducial marker within a target area of the dynamic environment;
displaying, by the user device in a device display, a digitally modeled representation of the target area;
positioning, by the user in the display, a digital fiducial marker;
capturing and displaying, by the user device, a real-time digital image of the target area and the physical fiducial marker;
associating the digital fiducial marker with the physical fiducial marker;
repositioning, by the user in the display, the modeled representation of the target area to match the captured digital image; and
displaying, by the user device, the AR information in conjunction with the real-time digital image of the target area, the AR information being displayed in a position adjacent to a location of the digital fiducial marker on the display.

2. A method according to claim 1 further comprising:
transmitting, by the user device, position information to a central processor; and
receiving a digital model of the target area from the central processor.

3. A method according to claim 2 further comprising:
generating the modeled representation using the digital model of the target area.

4. A method according to claim 1 further comprising:
receiving the AR information from the central processor.

5. A method according to claim 4 further comprising:
transmitting to the central processor at least a portion of the captured digital image of the target area, the at least a portion of the captured image including an image of the physical fiducial marker.

6. A method of displaying on a user device augmented reality (AR) information associated with a physical fiducial marker disposed within a target area, the method comprising:
displaying to a user of the user device a digitally modeled representation of the target area;
receiving user-entered placement information for a digital fiducial marker, the placement information establishing a position of the digital fiducial marker relative to the modeled representation of the target area;
capturing by an image capturing device a real-time digital image of the target area and the physical fiducial marker;
associating the digital fiducial marker with the physical fiducial marker;
receiving image placement information from the user to match the modeled representation of the target area to the captured digital image; and
displaying the AR information in conjunction with the real-time digital image of the target area, the AR information being displayed in a position adjacent to a location of the digital fiducial marker in the image.

7. A method according to claim 6 further comprising:
transmitting, by the user device, position information to a central processor; and
receiving a digital model of the target area from the central processor.

8. A method according to claim 7 further comprising:
generating the modeled representation using the digital model of the target area.

9. A method according to claim 6 further comprising:
receiving the AR information from the central processor.

10. A method according to claim 9 further comprising:
transmitting to the central processor at least a portion of the captured digital image of the target area, the at least a portion of the captured image including an image of the physical fiducial marker.

11. A mobile user device comprising:
a user interface comprising a display screen and a user input mechanism;
a communication interface configured for selective communication over a network;
an image capturing device for selectively capturing digital images;
a data processor in communication with the user interface, the communication interface, and the image capturing device;
a memory accessible by the data processor and containing an augmented reality (AR) display application configured to cause the data processor to
display on the display screen a digitally modeled representation of a target area;
receive, from a user via the user input mechanism, placement information for a digital fiducial marker, the placement information establishing a position of the digital fiducial marker relative to the modeled representation of the target area;
receive, from the image capturing device, a real-time digital image of the target area and a physical fiducial marker disposed within the target area;
associate the digital fiducial marker with the physical fiducial marker;
display the digital image of the target area on the display screen with the modeled representation of the target area and the digital fiducial marker;
receive, from the user via the user input mechanism, image placement information to position the modeled representation of the target area and the digital fiducial marker on the display screen relative to the captured digital image; and
display on the display screen the AR information in conjunction with the real-time digital image of the target area, the AR information being displayed in a position adjacent to the digital fiducial marker.

12. A mobile user device according to claim 11 wherein the display application is further configured to cause the data processor to
transmit, via the communication interface, position information to a central processor,
receive a digital model of the target area from the central processor, and
generate the modeled representation using the digital model of the target area.

13. A mobile user device according to claim 11 wherein the display application is further configured to cause the data processor to
receive the AR information from the central processor.

14. A mobile user device according to claim 13 wherein the display application is further configured to cause the data processor to
transmit to the central processor at least a portion of the captured digital image of the target area, the at least a portion of the captured image including an image of the physical fiducial marker.
